(19) United States
(12) Patent Application Publication
(10) Pub. No.: US 2009/0248490 A1
(43) Pub. Date: Oct. 1, 2009

(54) System and method of competitive business analysis

(76) Inventor: Craig T. Moncreiff, San Diego, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 12/157,584

(22) Filed: Jun. 10, 2008

Related U.S. Application Data
(60) Provisional application No. 61/070,900, filed on Mar. 26, 2008.

(51) Int. Cl. G06Q 10/00

(52) U.S. Cl. 705/10; 707/3

(57) ABSTRACT

A system and method are provided for performing competitive business and/or financial analyses. The systems accept input concerning a specific business such as the industries and geographical markets in which the business operates. Based on the type of report selected, the system retrieves business and financial data concerning the industries and markets, and then computes a number of relevant statistical factors. Tabular and/or narrative reports are generated based on the computed statistical factors.

### CROSS-REFERENCE TO RELATED APPLICATIONS

This application is a continuation of U.S. Provisional Patent Application Ser. No. 61/070,900 filed Mar. 26, 2008, which is hereby incorporated in its entirety by reference herein.

### FIELD OF THE INVENTION

The present invention relates generally to business planning and analysis, and more particularly to methods and systems to easily and efficiently provide detailed competitive business analysis tailored to a specific business.

### BACKGROUND OF THE INVENTION

In business planning it is essential to have an accurate understanding of the market and the competition. For instance, when expanding or growing a business it is important to understand the market and potential competition before opening a new store or introducing a new product or service. That a business must understand the market and competition is equally true of a startup company entering the market for the first time, a small company wanting to expand and grow, and an established company seeking new opportunities.

To some extent, a basic understanding of a market and the position of a business in that market may be acquired through anecdotal evidence, experience, customer feedback, or internal financial data. However, a more rigorous understanding of a market and/or the competition may only be gained through a more thorough statistical analysis of the market, the business itself, and the competitors operating in that market.

Some analyses are available in the form of an industry specific market analysis report from a market research firm. These reports are generally very expensive and usually provide a high-level view of industry growth, market fundamentals, trends in the industry, and so on. What is often needed, however, is a focused analysis directed toward a specific market in a specific geographic region. For instance, a high-level analysis may show that an industry is growing nationally, but miss that the same industry is over-concentrated in a specific region or city. There are few, if any, sources of statistics and analysis available to address specific industries within specific geographic markets.

Industry wide statistics may be available through Industry or Trade Associations, as well as through financial statement compilers such as Integra, Financial Research Associates, ProfitCents, and RMA (the Risk Management Association). The data available through such sources are typically based on a sampling of businesses within an industry and, thus, the data provides an interpolated picture of an industry. For example, these types of analyses are able to determine the average rents paid in a certain industry as a percentage of sales. However, some analyses are not amenable to calculation based on an industry sampling. For instance, to determine the market share of door retailers in a given region, it would be necessary to have a database of all the door retailers and their sales volume in the region or market. Neither industry associations nor financial statement compilers have a comprehensive enough data set for this purpose.

Databases maintained by business credit bureaus may be sufficiently detailed and comprehensive to support focused market research. However, subscriptions to credit bureau databases are expensive, and identifying, calculating, and interpreting statistics relevant to a business is difficult and typically requires a market research specialist. Often thousands of variables need to be reviewed and incorporated, and as a result, detailed market and industry specific analyses are out of reach for all but the largest businesses. To meet some needs of smaller businesses, Bizminer, a secondary provider, provides raw data from the credit bureaus and computes various statistics including aggregate sales, concentration levels, start-up ratios and the like. While Bizminer makes this type of business analysis more available, in actual use, it remains beyond the capabilities of general business analysts to interpret, apply and describe in reports. Accordingly, there is room for improvement.

For example, the Bizminer system does not provide a mechanism or procedure to capture and analyze data of a specific business or company, such as a client business wanting to compare statistics relating to its own operations with national and regional norms or determine its share of a particular market. Further, the system only provides data by designated national, state or metro area not by actual sales territory or market; thereby skewing any result by forcing the actual sales territory metric into a single manufactured designated category. The system does not allow for multiple industries or segments to be used when determining a business' competition. Nor does it have the capability to individually review the selected competitors from a territorial listing; resulting in a further skewing by not having the correct aggregated competitor statistics. Bizminer does not contain statistics on individual consumers, thereby not allowing for either market analysis of consumer markets nor certain important competitive analysis where both business and consumer statistics are required. Bizminer also appears to be limited in the kinds of queries that can be made, does not perform an analysis for a specific company or for a particular purpose, and does not provide any conclusions including ranking or rating nor does it provide a narrative report interpreting and explaining the results of an analysis.

In view of the foregoing, it would be desirable to provide methods and systems for efficiently performing analyses of a specific client business.

It would be desirable to provide analysis of a specific business with regard to both commercial and consumer markets.

It would be desirable to provide numerical values or scores useful in determining the competitive position of an actual or prospective business in a market.

It would be desirable to provide methods and systems for calculating client and market specific analysis including market share, concentration by population index and utilization index.

It would be desirable to provide methods and systems that enable analysis to be performed on arbitrary geographic regions.

It would be desirable to provide methods and systems that allow for multiple industries when determining a business' competitive markets.

It would also be desirable to provide methods and systems for performing automated search queries for both competitive and market analysis.

It would be desirable to also provide methods and systems for automatically searching and ranking multiple markets as potential new markets for a business to enter or expand into.

And, it would be desirable to provide methods and systems for automatically providing both tabular and narrative reports that show and explain the analyses and draw conclusions for the end user.

### SUMMARY OF THE INVENTION

It is, therefore, an object of the invention to provide methods and systems for efficiently performing analyses of a specific client business.

It is an object of the invention to provide for the analysis of a specific business with regard to both commercial and consumer markets.

It a further object to provide numerical values or scores useful in determining the competitive position of an actual or prospective business in a market.

It is also an object of the invention to provide methods and systems for calculating client and market specific analysis including market share, concentration by population index, and utilization index.

It is another object of the invention to provide methods and systems that enable analysis to be performed on targeted arbitrary geographic regions.

It is an object of the invention to provide methods and systems for performing automated search queries for both competitive and customer market analysis.

And, it is also object of the invention to provide methods and systems for automatically providing both tabular and narrative reports that show and explain the analyses and draw conclusions for the end user.

These and other objects and advantages of the present invention are provided by a system and method that provides competitive business and/or financial analysis about a particular business in comparison to other businesses in the marketplace. A business owner or advisor selects a type of report and provides limited financial information about the subject business, such as information pertaining to sales, employees, markets, customers, and other relevant data. Data relevant to the selected type of report is also obtained from one or more business credit bureaus or other databases. The information and data are then analyzed both for the subject business and other businesses in the market after segmenting the data by industry, geography, and other relevant factors. This provides the business owner or advisor with information on where the business stands in comparison to other businesses in the industry, geographic region, or other factor.

### BRIEF DESCRIPTION OF THE DRAWINGS

The above, and other, objects of the invention will be apparent upon consideration of the following detailed description, taken in conjunction with the accompanying drawings, in which like reference characters refer to like parts throughout, and in which:

FIG. 1 is a simplified block diagram of a system in accordance with the principles of the present invention;

FIG. 2 shows an exemplary home page for the system of FIG. 1;

FIGS. 3A and 3B show illustrative forms for selecting an analysis;

FIG. 4 is an exemplary order form page;

FIGS. 5A and 5B are an illustrative questionnaire for gathering information about a business;

FIG. 6 is a simplified system flowchart;

FIGS. 7A through 7D show an exemplary tabular report generated by the system; and

FIG. 8 shows a representative template for a narrative report.

### GLOSSARY

In discussing the present invention, it will be convenient to use various terms and phrases as defined below:
Business-to-Business—a type of market in which a business provides products or services to other businesses.
Business-to-Consumer—a type of market in which a business provides products or services to individuals as consumers.
Class—the range of a statistical measure may be arbitrarily divided into sub ranges, or classes. For example, businesses may be segregated into classes, or classified, based on gross sales of: <$5M, $5-10M, $10-25M, etc.
Competitive Analysis—an analysis of a business' competitors in relation to a subject business.
Concentration—the percentage a specific industry represents in comparison to all industries.
Concentration by Population (or target) Index—the ratio of the number of businesses per capita (or per targeted consumer) in a particular industry and market to the number of businesses per capita (or per targeted customer) in the particular industry in a larger geographic area, such as statewide, region wide, or nationwide. As an illustrative example:

| | |
|---|---|
| Number of furniture stores in Chicago | 280 |
| Number of target customers | 400,000 |
| (house hold income of at least $50k). | |
| Concentration Rate | 0.0007 |
| Number of furniture stores in USA | 25,000 |
| Number of target customers | 40,000,000 |
| Concentration Rate | 0.000625 |
| Concentration by Population Index | 1.12 |

Concentration Index—the concentration of an industry in a given market in comparison to the concentration of the industry nationwide.
Consumer—An individual person that either fits the profile of a purchaser, or in fact, does purchase a given product or service.
Customer Market Research—research and analysis about current and/or prospective buyers of goods or services. The market may be either business-to-business and/or business-to-consumer.
Efficiency Index—the ratio of the sales per employee for the subject business to the sales per employee for an industry. An efficiency index may also be computed in-market.
Failure rate—for the period covered by an analysis, the percentage of businesses that no longer exist in the final year of the period but did exist in a prior year of the period. For example, for a three year analysis, the failure rate is the fraction of businesses that existed in years one or two, but not in year three compared to all businesses. The rate may be adjusted to account for consolidations or sale of a business.
Geographic Sales Territory—the geographic area in which a business sells its products or services. A geographic sales territory may be a nation, state, county, city, parish, school district, voting district, radius from a specified location, approximate drive time from a specified address, or other convenient delineation of a geographic area. A geographic sales area may include multiple disjoint areas, such as cities in multiple parts of the country.
In-market—statistics are said to be in-market when they are calculated based on a specified geographic area, which could be a state, county, road, zip code, metropolitan area, or other identifiable geographic area.
Index—the ratio of an analysis applied to a specified market to the same analysis applied to a larger, typically national, market. For example, a utilization rate index is the ratio of the utilization rate for a specified market to the utilization rate for a nationwide market.
Market share—the percentage of a market held by a business as calculated by dividing the sales of the business by the sales of the entire market being analyzed.
Market share class—business classification based on market share.
Sales per Business Unit—total sales divided by the number of business units.
Sales per employee—the ratio of annual business sales to equivalent full-time employees.
Search Analysis—a secondary analysis in which a selected analysis is repeated while varying an analysis parameter to search for an optimal value. For example, an expansion analysis may be computed for multiple industries and/or geographic areas to determine the best industry or area into which a business should expand.
Start up rate—the percentage of businesses that are new from one year to the next.
Subject Business—the client business that is being analyzed and for which the competitive analysis and research is being performed.
Target—a geographic, industry, or demographic subset.
Utilization Index—the Utilization Rate for a market divided by the national utilization rate (or the rate for a larger market).

| Sales of all furniture stores in USA | $10 billion |
|---|---|
| Number of target customers | 40 million |
| National Utilization Rate | $250 |
| (divided into) | |
| Chicago Utilization Rate (see below) | $300 |
| Utilization Index | 1.20 |

Utilization Rate—this is the sales for a particular industry in a specified market divided by the number of targeted customers in the specified market. For example:

| Sales of furniture stores in Chicago | $120 MM |
|---|---|
| Number of target customers | 400,000 |
| (house hold income of at least $50k). | |
| Utilization Rate | $300 |

### DETAILED DESCRIPTION

In the following paragraphs, the present invention will be described in detail by way of example with reference to the attached drawings. Throughout this description, the preferred embodiment and examples shown and discussed herein should be considered as exemplars, rather than as limitations on the present invention. As used herein, present invention refers to any one of the embodiments of the invention described and their equivalents. Furthermore, references to an embodiment of the present invention having a feature does not mean that all embodiments of the invention must include the recited feature.

The present invention may be used to perform many types of business analysis, including without limitation analysis for expansion, business planning, acquisition or divestiture, appraisals, and annual reports, among others. Expansion Analysis focuses on measures including the competitiveness of a subject business in a target market, and on the stability and growth of the customers in the target market. Such measures may include, for example, the concentration of competing businesses, the number of start-ups and failures, the size of competitive businesses, whether any competitor has a dominant market share, sales per business unit in comparison to national averages, efficiency, and other relevant statistics. In a business-to-business market, the measures may also include statistics related to the target businesses, such as start-up, growth, and failure rates, concentration numbers, and other factors that would indicate an ability to sell into the target market. In a consumer market, the measures may also include statistics related to the target consumers, such as demographics and the growth and stability of one or more particular individual consumer classifications.

A Business Plan Market Analysis provides start-up entrepreneurs or corporate managers an understanding of potential markets for a new enterprise, product, or service. Data and analysis is needed to convince investors or decision makers to fund or approve of the new enterprise. Statistical measures such as a concentration index or utilization rate can indicate that a potential market is underserved; start-up and failures rates provide an indication of risk; and sales per employee provide performance targets. Such information is useful for gauging both consumer and business directed markets.

When buying or selling a business, or portion thereof, it is important to have an accurate description and assessment of the subject business. A Merger and Acquisition Analysis focuses on the potential for a business or business unit. As such, an understanding of the current market is needed, such as that provided by the Business Planning Analysis described above, as well as an understanding of potential markets, such as that provided by an Expansion Analysis.

As discussed above, the ability to enter data concerning the subject company and compute competitiveness metrics and to compare company statistics with market or industry statistics provides a wealth of information for judging the potential value of a purchase or sale. Moreover, in a preferred embodiment of the present invention, the system automatically searches for additional market opportunities and to compile, analyze and report on potential markets can make a business more valuable and therefore more marketable to potential buyers.

The present invention is also useful for general business appraisals and annual financial reports. To appraise the value of a business it is important to consider measures such as market share, sales, start-up and failure rates, and other such statistics. Because appraisers may not have the funds or resources to have ready access to accurate market data, there may be a tendency to rely on anecdotal data and avoid a rigorous analysis. Advantageously, the present invention accepts financial data concerning a subject company and automatically analyzes the data in relation to the market and provides a report on its findings, which may be incorporated into a business appraisal. Further some approaches to valuation include the comparison of the sales price of like-kind businesses (comparables) to the subject business. Understanding the market in which the comparables were priced can have a bearing on the application of their sales prices to the subject business.

Analogously, business financial data and market data may be analyzed to provide information for an Annual Report. Such information can include market share and growth, potential new markets, and the like.

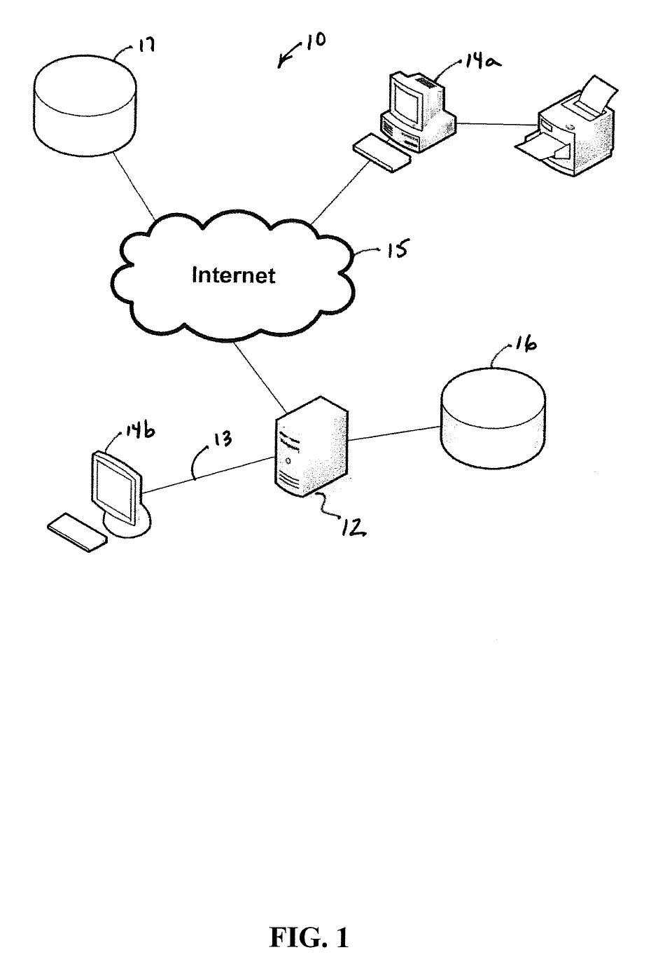

Referring now to FIG. 1, system 10 includes computer server 12 suitably programmed to implement the user interfaces, data gathering routines, and statistical analyses described herein below. Client computers 14a and 14b are connected to server 12 using available networking technology. In a preferred embodiment of the present invention a computer server on a widely accessible network such as the Internet provides a web site through which anyone may easily and economically obtain important business analysis. For example, client 14a is connected to server 12 using internet 15. Alternatively, the connections to server 12 may be limited only to computers on a local area network (LAN), an intranet, a virtual private network (VPN), or the like, so that only selected persons or groups may access the system. For instance, client computer 14b is connected to server 12 over a local network 13.

Server 12 is connected to data storage device 16 which may include file systems and databases. Storage device 16 may, for example, contain data captured from client companies, the results of previous analyses, computer software, and the like. Server 12 is also connected to external, or third-party, databases 17 which may be for example databases provided by business credit bureaus. Server 12 may connect to databases 17 over the Internet or using a direct connection.

As one skilled in the art would understand, FIG. 1 is a simplified schematic representation of system 10. Elements and devices common to a commercial presence on the Internet such as devices and subsystems for providing backups, ensuring availability, load balancing, security, encryption, authentication, and the like are omitted from FIG. 1 for reasons of simplicity and clarity.

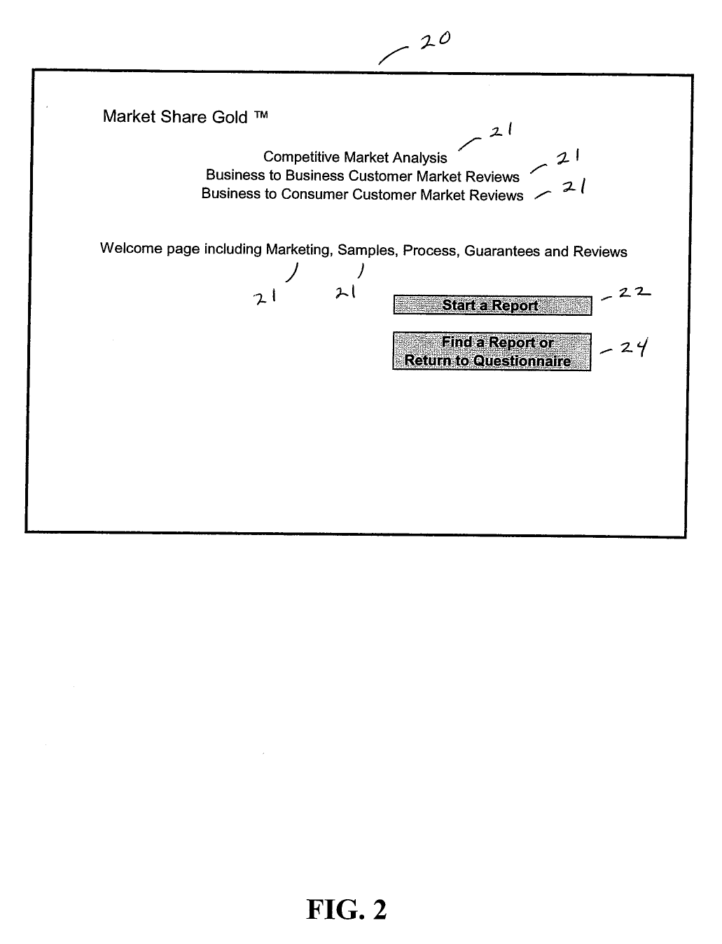

Preferably, computer server 12 provides appropriate server software, such as a web server, to provide a user interface for the system so that the system can accept data and analysis requests from and return results to a client business. Preferably, the system uses web-based technologies to implement the user interface. For example, FIGS. 2 through 5, which are described more fully below, show exemplary web forms for collecting needed data from an end user.

In general, a process or method for competitive business analysis according to the present invention includes steps of gathering data about the business or company that is the subject of the competitive market analysis. The gathered data includes information identifying the business, the industry, industries or segments it operates in, and data about gross sales history, business size, market geography, and customers. It is also desirable, where customer markets include a business to business component, to have an indication of whether an increase in the number of clients or growth in client sales volume is more beneficial to the subject business. And whether and to what extent such companies make sales beyond their known market in terms of catalogs or internet sales.

Appropriate data covering a predetermined time-span, preferably three years, is then retrieved from a credit bureau database. The data is segregated by industry based on North American Industry Classification System (NAICS) codes, yellow pages description, or other applicable classification system. The data is further segregated based on geographic considerations such as nation, state, county or parish, metropolitan area, neighborhood, distance or driving time from a reference location, or other geographic metric. The data may be further segregated by customer demographics. Or in the case of businesses, the data may be individually reviewed and culled for those specifically known competitors or customers, as well as reviewed for purposes of manually changing the business data, if more accurate data is available or for excluding the business if only partial data is available or where the business is known to not be a competitor or customer. Further, in the case where no data or partial data is available, the user of the system may “model” the data by allowing the system to automatically compute sales, for example, based on sales per employee of like-kind businesses and where the number of employees is available. Further the sales volume of competing businesses may be adjusted to reflect the extent to which their geographic sales territory or market, overlaps with the subject business. In that only the portion of sales that are accrued from the overlapping territory would be considered in the subject business' market share and other calculations.

Statistics relevant to the requested type of analysis are calculated based on the segregated data. Among others, the statistics may include the number of similar businesses in the market, the number of total businesses in the market, sales volume per business, average sales volume of the businesses, total sales volume in the market, the number of similar businesses that have started or failed in the market or in total, and the number of employees.

Indices are computed relating the statistics calculated from the segregated data to industry, market, regional, and/or national statistics. For example, if there are 0.75 motorcycle dealers per thousand businesses nationally, the national concentration of motorcycle dealers is 0.075%. If a specified geographic area, e.g., 100 miles circle around Phoenix, Ariz., has a concentration of 0.095%, then the concentration index is 0.095/0.075 or 1.26. In narrative terms, a concentration index of 1.26 indicates that the specified area, e.g., Phoenix, has 1.26 times as many motorcycle dealers per business than for the nation as a whole. Indices may also be calculated to compare local statistics to regional statistics, such as motorcycle dealer concentrations in Phoenix compared to concentrations in Arizona, the southwestern United States, or other relevant geographic area. Analogously, indices may be calculated based on other statistics such as startup and failure rates, industry growth rates, sales per employee.

Statistics and indices about the subject company are also computed. The statistics and indices about the subject company and those computed based on industry, national, and/or regional segregated statistics are compared and contrasted. The comparisons form a basis for drawing conclusions about the business and its prospects. The specific statistics and indices computed is dependent on the type of analysis being requested. Table 1, is illustrative of some of the specific statistical computations that may be performed for various types of requested business analysis.

TABLE 1

| | | Start-up or | Appraisals or | |
|---|---|---|---|---|
| | M&A or | Business | Competitive | Market |
| Selected Analysis | Expansion | Planning | Performance | Research |
| Market Analysis: | | | | |
| Market Share | X | | X | |
| In-market | | | | |
| Concentration Index | X | X | X | |
| Competitor Class and | X | X | X | |
| Trend | | | | |
| Market Share Class | X | X | X | |
| and Trend | | | | |
| Sales per business unit | X | X | X | |
| index | | | | |
| Start-up rate | X | X | X | |
| Failure rate | X | X | | |
| Efficiency Index | X | X | X | |
| Customer Analysis: | | | | |
| Industry/Consumer | X | X | X | X |
| growth | | | | |
| Start-up rates | X | X | X | X |
| Failure rates | X | X | X | X |
| Concentration Index | X | X | X | X |

In a preferred embodiment of the present invention, the system repeats various analyses while varying selected parameters of the analyses, effectively conducting a search over the relevant analytical parameters. For instance, an expansion analysis or start-up analysis may repeat the analysis for a number of geographic regions. Regions to be considered may be provided in a list by the subject business, or may be obtained by modifying, e.g., growing, shrinking, or moving, a previously analyzed region. The search may then identify the best geographic area for start-up or expansion. Analogously, a search may be conducted over a number of industries to identify industries in to which to expand. Table 2, below, shows illustrative searches that may be performed for different types of analyses.

TABLE 2

| | | Start-up or | Appraisals or | |
|---|---|---|---|---|
| | M&A or | Business | Competitive | Market |
| Selected Analysis | Expansion | Planning | Performance | Research |
| Geographic Search: | | | | |
| Lowest Concentration | X | X | | |
| Lowest Efficiency | X | | | |
| Competitive Scale | X | | | |
| by Mkt Share | | | | |
| High/Low Start-ups | X | X | | |
| Industry Search: | | | | |
| Highest Concentration | X | X | | X |
| Highest Start-up Rate | X | X | | X |
| Fastest Growth | X | X | | X |
| Consumer Analysis: | | | | |
| Fastest Growth | X | X | | X |
| Largest Target Market | X | X | | X |

After completing the analyses, indexing, comparisons, and searching, the results are presented to the requesting user. Preferably, the results are provided in both tabular and narrative forms.

An exemplary user interface to the above-described system is shown in FIGS. 2-5. The interface is preferably web-based to take advantage of the ecumenical availability of web browsers; dedicated interfaces may also be used, however. FIG. 2 shows illustrative home page or portal 20 to the competitive business analysis system. Web page 20 provides links 21 to additional information such as sales and marketing information, information about the services for business customers and consumers. In addition, web page 20 includes navigation elements, such as buttons 22 and 24 for starting an new analysis or retrieving a previously started or completed analysis. As one skilled in the art would appreciate, the arrangement and layout of the web pages, as well as the data, forms, and navigational controls displayed on the web pages may be altered and modified in innumerable ways without changing the underlying functionality of the analytical system disclosed herein. For example, buttons 22 and 24 may be replaced by a other navigation elements, such as a menu or other user control.

To start a new report, a user or customer activates button 22. Alternatively, by activating button 24 the user is able to access previous analyses as will be described in more detail below.

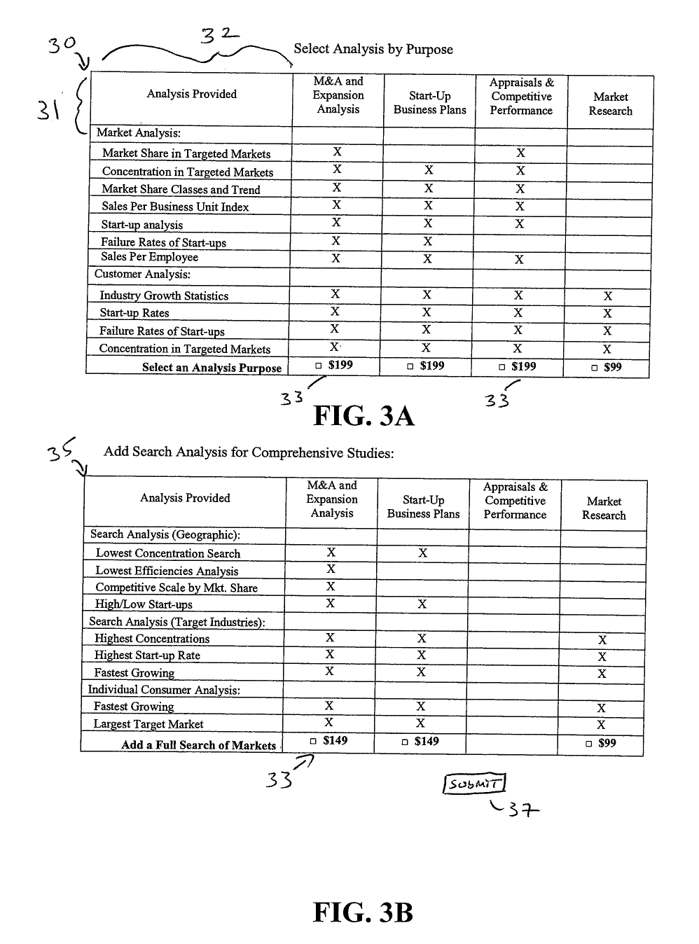

When starting a new analysis, the user is prompted to select a type of analysis. Preferably, a matrix, chart, or table, such as matrix 30 shown in FIG. 3A is displayed for the user. Matrix 30, which may be conveniently displayed as an HTML table, indicates the correspondence between the types of reports that are available and the specific analyses calculated by the system. Row 31 lists the types or kinds of reports that are available, and column 32 lists the statistics and analyses the system can compute. An ‘X’ in the matrix indicates that a statistical analysis listed in the marked row is performed when the type of report in the market column is performed.

Controls, such as checkboxes 33, are provided so that the user may select the desired analysis to be performed. Preferably, the costs associated with the different types of report are indicated on matrix 30. In addition, the names of the report types in row 31 and of the statistical analyses in column 32 are preferably active hypertext links. Selecting a link takes the user to a web page with additional information about the selected item, such as a help screen of glossary. For example, by selecting “Start-up Business Plans” a user is taken to a web page with a description of a start-up business plan report, which may include the types of analyses that are computed, the relevance of the analysis to the report, when such a report might be desirable, and other helpful material.

In addition to matrix 30, another matrix or table may be displayed with various optional or add-on features. For example, matrix 35 of FIG. 3B provides information on the types of searches that can be performed in connection with some types of reports. Matrix 35 may be displayed concurrently with matrix 30. Alternatively, after a user selects a basic report type in matrix 30, the user may be given the option to add optional features that are relevant to the selected type of report. Upon activating submit button 37, the form data is sent to server 12.

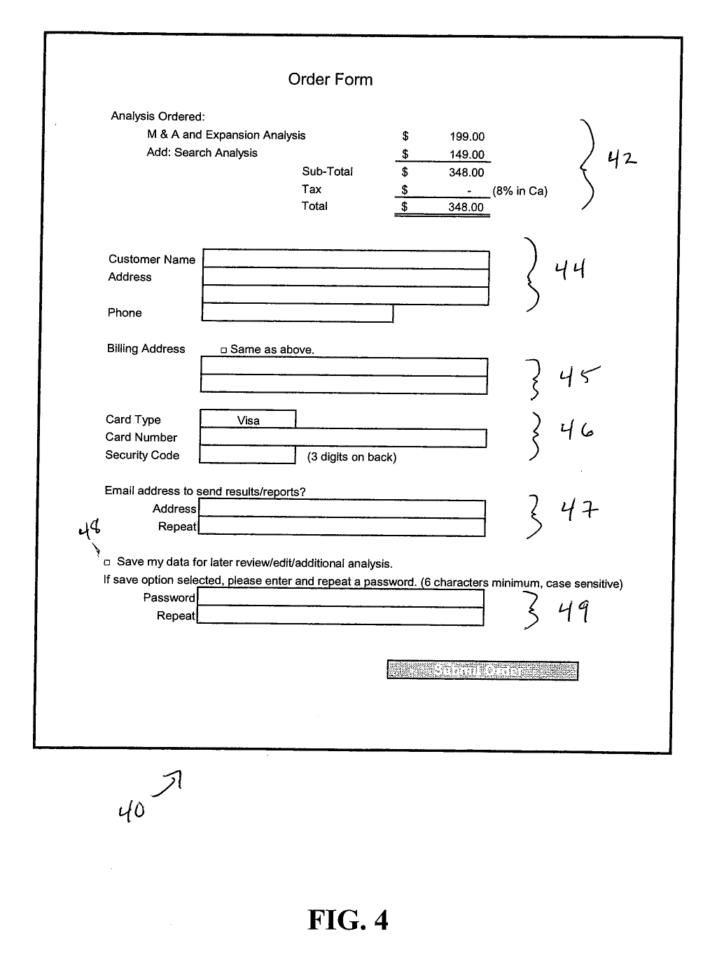

After selecting a report and optional add-on features, such as market search, order form 40 of FIG. 4 is presented to the user. Order form 40 may include invoice section 42 showing the costs and fees for the selected search, customer data section 44 for entering customer data, sections 45 and 46 for entering billing and credit card information, and contact information section 47 for entering preferred addresses for sending reports and contacting the customer. Preferably, a control is provided, such as checkbox 48 is provided so that a user can save data for later retrieval. A password may be required to be entered into password fields 49 to help safeguard the information and data stored on the system.

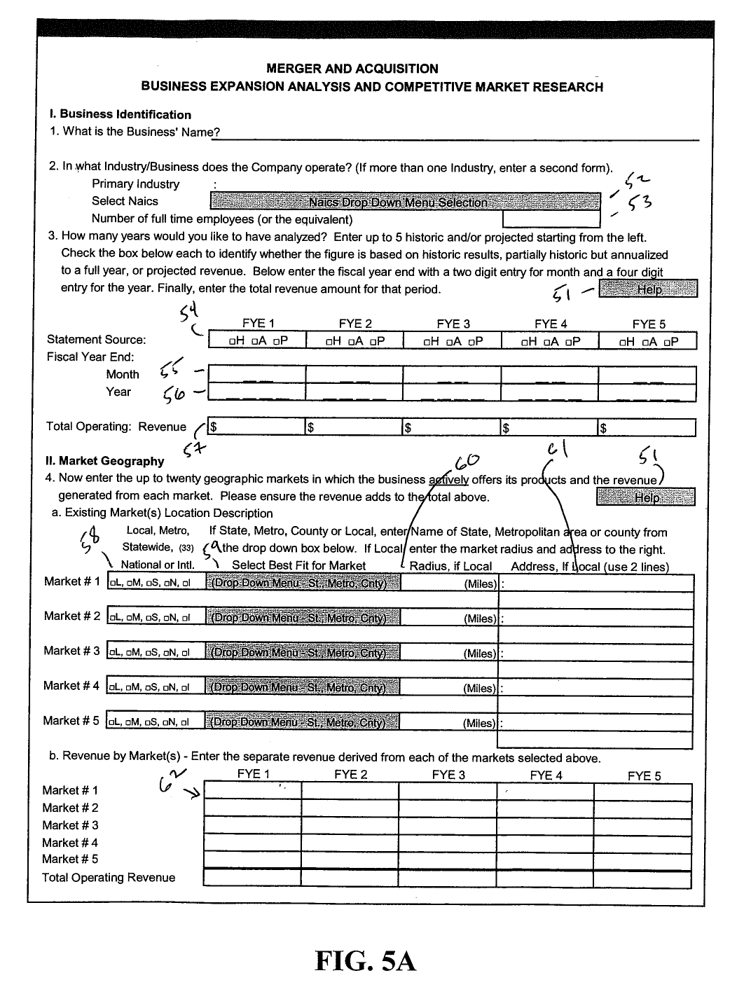

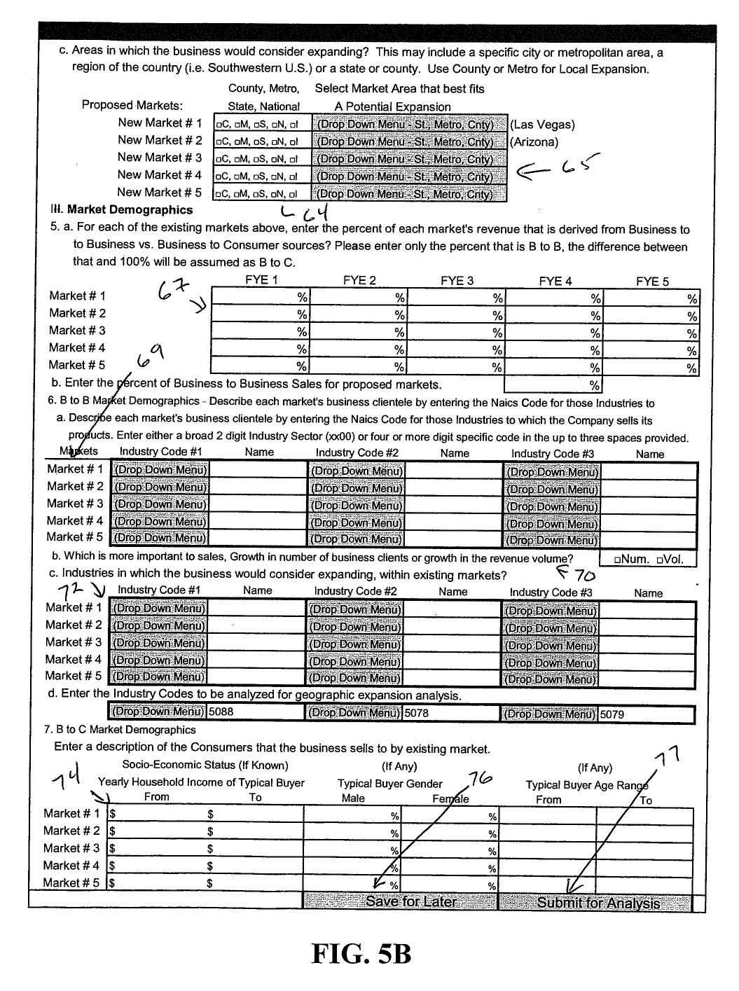

As discussed above, a competitive business analysis requires information concerning the business that is the subject of the analysis. Upon submitting the order form the user is presented with a questionnaire to collect data needed for the type of report that has been ordered. An illustrative questionnaire suitable for collecting data needed for a Mergers and Acquisition or Business Expansion Report is shown in FIGS. 5A and 5B. The form is relatively simple, does not request a significant amount of data, and should be easily filed out in a short period of time. Nevertheless, help buttons 51 are provided throughout the form to assist users with detailed explanations or examples. In general, form data entry fields are provided to gather the needed information. Preferably, the data entry form is organized into sections, such as separate sections for entering data about the business, market geography, market demographics. The sections may be presented to the user as parts of one large form, or as a series of forms.

The exemplary forms of FIGS. 5A and 5B, include section I for collecting business data such as the name of the business, the primary industry (by North American Industrial Classification System or other classification) of the business, the size of the business, and financial data concerning past or forecast sales. In particular the form includes drop down list 52 for selecting an appropriate NAICS code (or codes or codes by market or by franchise name) and field 53 for entering the number of full-time (or equivalent) employees. A grid of data entry fields are provided for entering up to five years of sales results or forecasts. Source fields 54 provide check boxes to indicate whether the data for the corresponding year is historic (‘H’), annualized (‘A’), or forecast (‘F’). Month and Year fields 55 and 56 specify the end of the corresponding fiscal year. Total Operating Revenue field 57 is for entering total revenues for the corresponding fiscal year.

Section II of the form is for collecting data about market geography. As such, the form provides sets of input fields for entering geographical data on several markets. The input fields include checkboxes 58 for indicating whether the market is of a local, metro, state, national, or international in scale; drop down list 59 for more narrowly specifying a local, county, metro or state market area; and fields 60 and 61 are for entering a reference address and radius to further specify a local market area. Fields 62 are provides for inputting annual revenue for each market. Lastly, fields 64 and 65 are provided for entering geographic markets that might be considered for expansion.

Section III of the form is provided to collect data on current and prospective market demographics. For example, table 67 is used to gather data on the relative contribution of business-to-business transactions for each of the markets identified in section II. Table 69 is used to gather data on the types of businesses and industries that are its customers in the identified markets. Checkbox 70 is provided so the user can indicate which type of growth is more important to sales revenue: growth in the number of clients or growth in sales to existing clients. Information on potential industries a business would consider expanding into is gathered using table 72. Table 74 is used to gather data analogous data on the business-to-consumer portion of the subject business.

At any time during data entry, the user may select ‘Save for Later’ button 76 to save the data entered thus far. For example, this may allow the user to collect or verify the accuracy of needed information or to temporarily suspend data entry while attending to other matters. When ready to resume data entry, the user may select button 24 from the system home page (FIG. 2) to return to a partially filled in form. When data entry is complete, the user selects button 77 labeled ‘Submit for Analysis.’

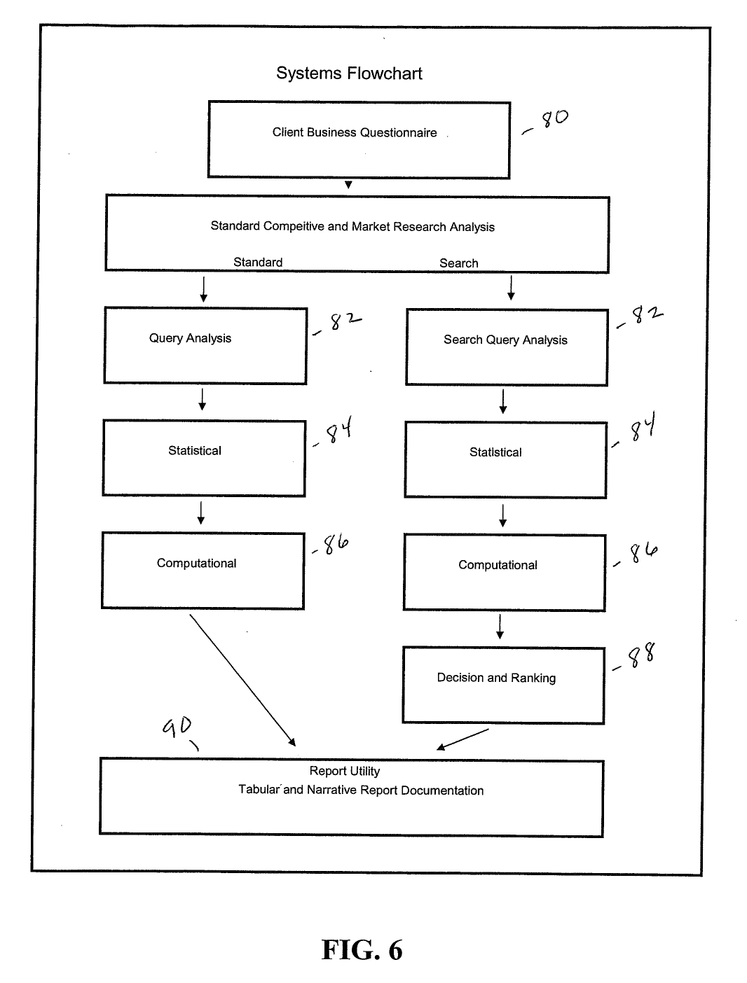

FIG. 6 is a simplified block diagram representing the basic data flow of the business analytical system of the present invention. After a user has selected a type of report and options, the applicable questionnaire is provided at block 80. The function of block 80 may be provided or performed by various modules or systems to generate, transmit, receive, parse and analyze applicable data collection forms, such as the illustrative forms of FIGS. 5A and 5B. The modules implementing function block 80 may include web server or other software for selecting and delivering applicable forms to the user, saving partially completed forms, and collecting and saving data from completed forms.

After the data has been collected, subsequent processing depends on whether a search analysis has been requested. The information collected from the input forms data is analyzed to form database queries to retrieve data needed for the analysis. If a search analysis was not requested, Query Analysis module 82 formulates queries based on data provided in the input forms to extract data from the credit bureaus regarding businesses in the relevant industries and markets. If a search analysis had been requested, Query Analysis module 82 also creates queries relevant to the proposed markets and/or industries indicated on the data input forms. By analyzing the queries in view of the type of report requested, queries may be formulated to reduce cost. For example, knowing that a search analysis is desired, query analysis module 82 can formulate a broad query to include both current and prospective industries and markets. As discussed below, subsequent processing steps segregate the data by industry and geography, so a query covering all relevant industries and geographical areas may be more cost effective than multiple queries that each address only one industry or geographical area. Queries may also be prepared concerning demographics of the current and proposed markets.

The output of the query analysis module is used by statistic module 84, to query available databases to gather needed data. For example, statistics module 84 may query databases provided by business and/or consumer credit bureaus as well as census and other databases of consumer demographics. The raw data from the database queries is segregated by industry based on NAICS code or yellow pages classification. Business data is also segregated geographically based on nation, state, county, metro area, city, and the like. A geographic information system (GIS) or mapping system so that market areas can be defined based on a radius, polygon, neighborhood or a drive time from a reference point, such as a specified address or location.

Computation module 86 calculates the various statistical measures and indices based on the retrieved and segregated data, as well as corresponding data from the questionnaire concerning the subject business. The computation module determines what calculations to perform based on input from the analysis and pricing page (e.g., the selected type of report).

If a basic analysis was requested, the output of computation module 86 is provided to report utility module 90. However, if a search analysis has been requested, computation module 86 performs the calculations for the permutations of the prospective markets and industries provided by the client on the data collection form. The results for each permutation are then scored and ranked by decision and ranking module 88, before being passed on to report utility module 90.

Report utility module 90 generates tabular and narrative reports based on the output of computation module 86 and/or decision and ranking module 88. Tabular reports provide the analytical results in a compact numerical or graphical format, and accompanying explanatory and definitional text. The narrative report, in contrast, includes a full discussion of the analyses performed, their relevance to the type of report being prepared, any conclusions or observations to be derived from the analyses, as well as figures, charts, diagrams, and other material needed to understand the report. Preferably, the narrative report is designed to be a stand-alone analytical document as well as to be readily incorporated into a primary report such as, for example, a Merger and Acquisition Confidential Business Memorandum or business appraisal.

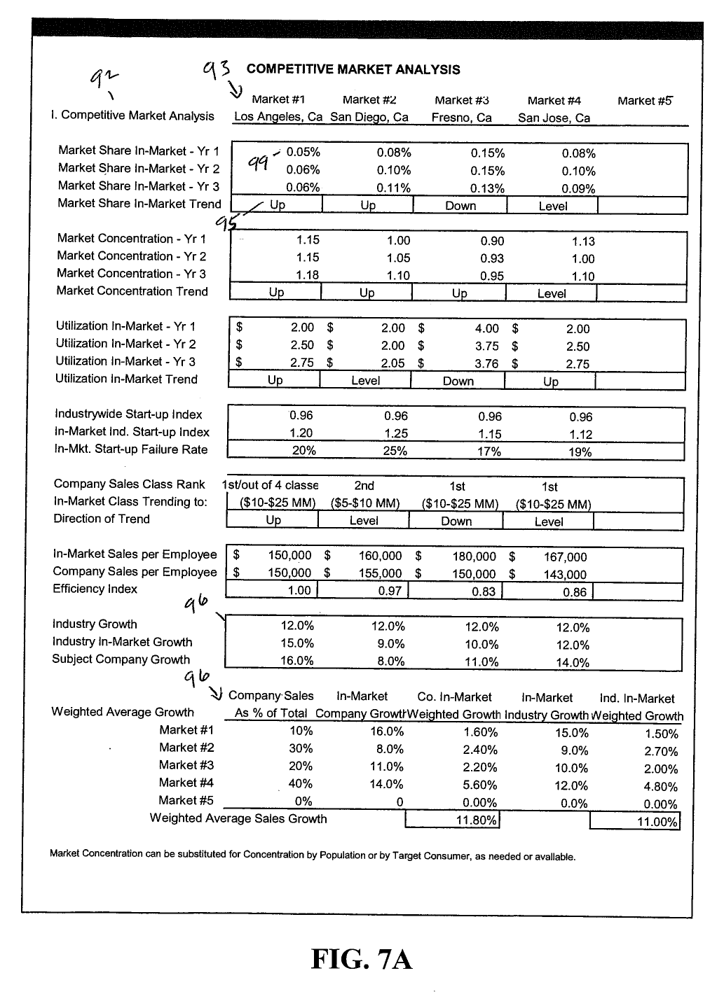

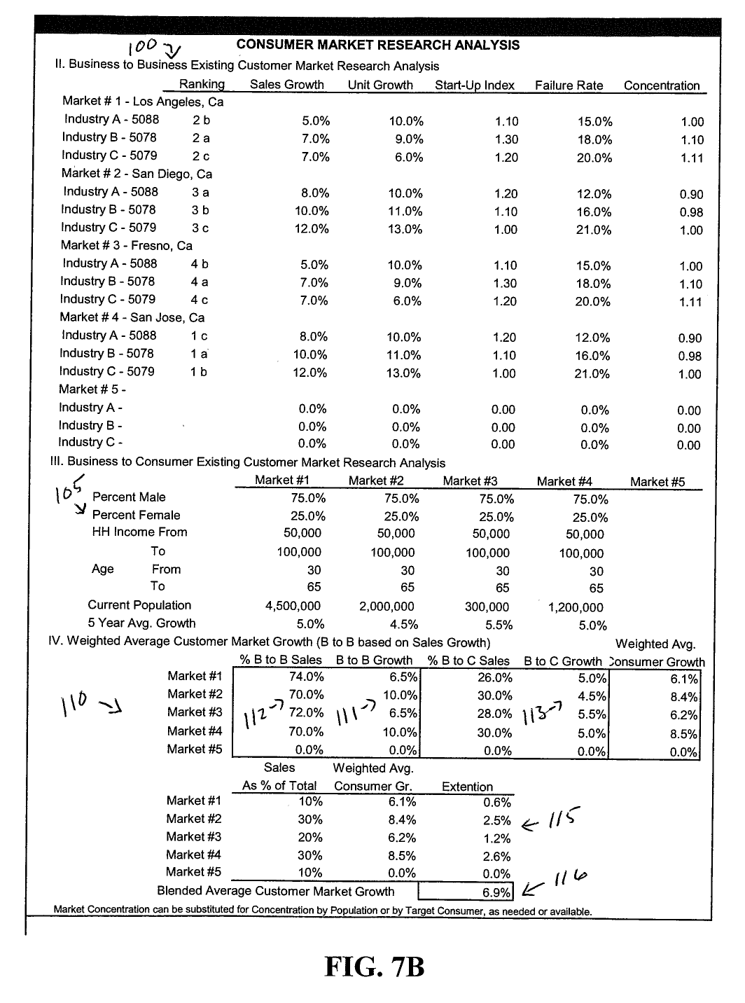

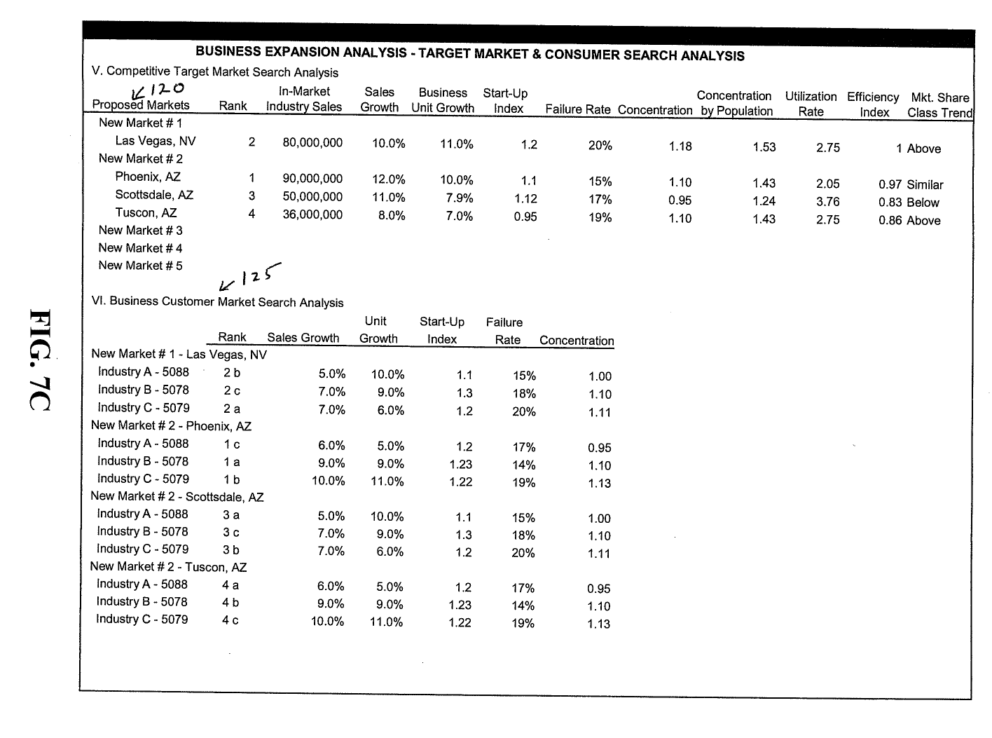

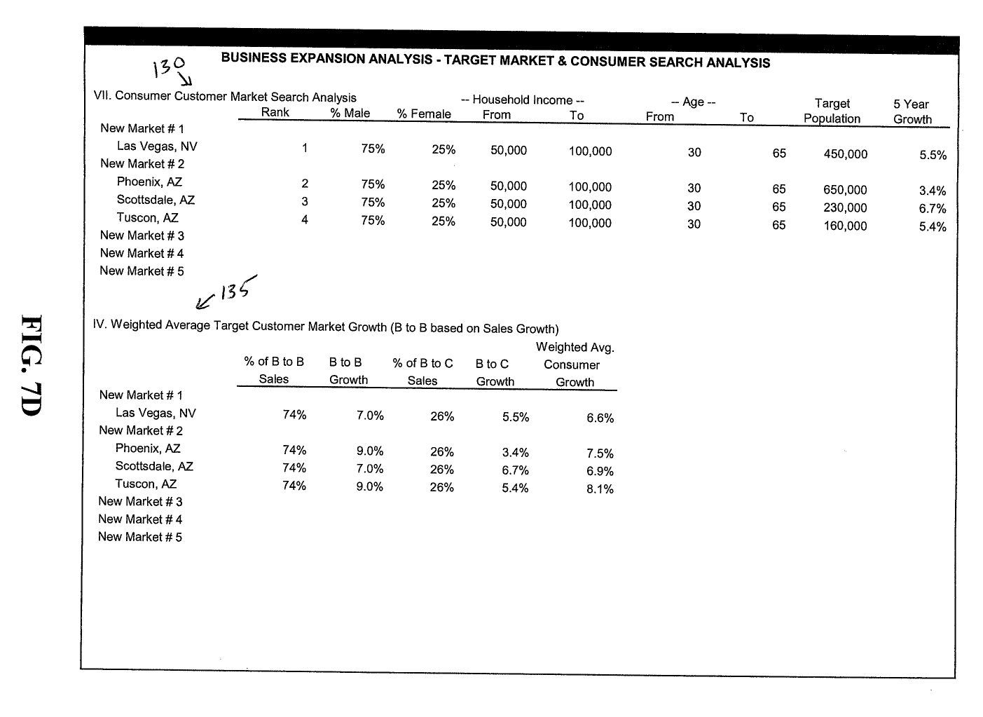

An illustrative tabular report is provided in FIGS. 7A-7D. A preferred tabular report includes a number of sections relevant to the type of report that has been requested. For example, the illustrative M&A Confidential Business Memorandum or report shown in FIGS. 7A-7D includes eight sections:
Competitive market analysis,
Business-to-business existing customer market research analysis;
Business-to-consumer existing customer market research analysis;
Weighted average customer market growth;
Competitive target market search analysis;
Business customer market search analysis;
Consumer customer market search analysis; and
Weighted average target customer market growth.

In competitive market analysis section 92, up to twenty markets in which the subject business currently operates are compared. The comparisons are based on various computations performed by the system and may include market share, start-up index, company sales class rank, efficiency index, and growth rate. Within each category of comparison, the results for a number of previous years is shown along with a trend indicator. For example, in FIG. 7A column 93 shows market share 94 of the subject company for the last three years and indicator 95 showing an upward trend. For computations related to growth, table 96 shows weighted or blended averages comparing the subject business to industry norms for the analyzed market(s).

FIG. 7B shows existing customer market research analysis for business customers, section 100, and consumers, section 105. For each market, business customer section 100 shows several factors that characterize the stability and growth of business-to-business transactions in the industries in which the subject business operates. The relevant factors include sales growth, unit growth, start-up index, failure rate, and concentration rate in each market. Analogously, section 105 shows several factors characterizing the stability and potential growth for sales and services to consumers.

Weighted average customer market growth, section 110 in FIG. 7B, shows a weighted or blended growth rate for the business' customers. In a preferred embodiment of the present invention, an average business-to-business growth rate is calculated based on the industries in which the subject business operates and their relative contribution to total business-to-business revenues. The computed average business-to-business growth rate is then averaged with the business-to-consumer growth rate based on the percentage 112 of revenue attributed to each type of customer. The result is the weighted average consumer growth 113 for a given market. The results for the market are then combined according to the relative contribution 115 of each market to yield a blended average customer market growth 116.

FIG. 7C shows section 120 with an exemplary competitive target market search analysis which provides results for markets in a specified geographical area or in a broader target region into which the company may want to expand. The section of the tabular report shows the markets that were examined in each of the geographic areas selected by the user. The results, which may vary in number depending on the search criteria, are weighted based on industry and then ranked or sorted. Exemplary statistical analyses include in-market industry sales, sales growth, business unit growth, start-up index, failure rate, concentration, concentration by population, utilization rate, efficiency index, and market share class trend.

Market search analyses for business customers and consumer customers are shown in sections 125 and 130, respectively. The market search analysis computes and ranks statistics for comparing geographical markets and industries within those markets. This information provides guidance as to which markets may be worth entering. Statistics for business customers are ranked by geographical market and by industry and may include statistics on sales growth, unit growth, start-up index, failure rate, and concentration. Statistics for consumer customers are ranked based on a weight calculated from population and growth.

Weighted average target customer market growth, shown in section 135, is a weighted or blended growth rate for the business' target customers in the target geographic markets. The growth rates for targeted industries and geographical markets are weighted and averaged in a manner similar to the calculation of weighted average customer market growth, discussed above and shown in section 110.

The tabular report provides numerical results that can be compared and contrasted, it may not be readily apparent how to interpret the results or use the results to draw conclusions that may be used in guiding business decisions and planning. Therefore, it is important to provide an optional narrative report in which various conclusions, recommendations, and interpretations are provided based on the numerical results in the tabular report.

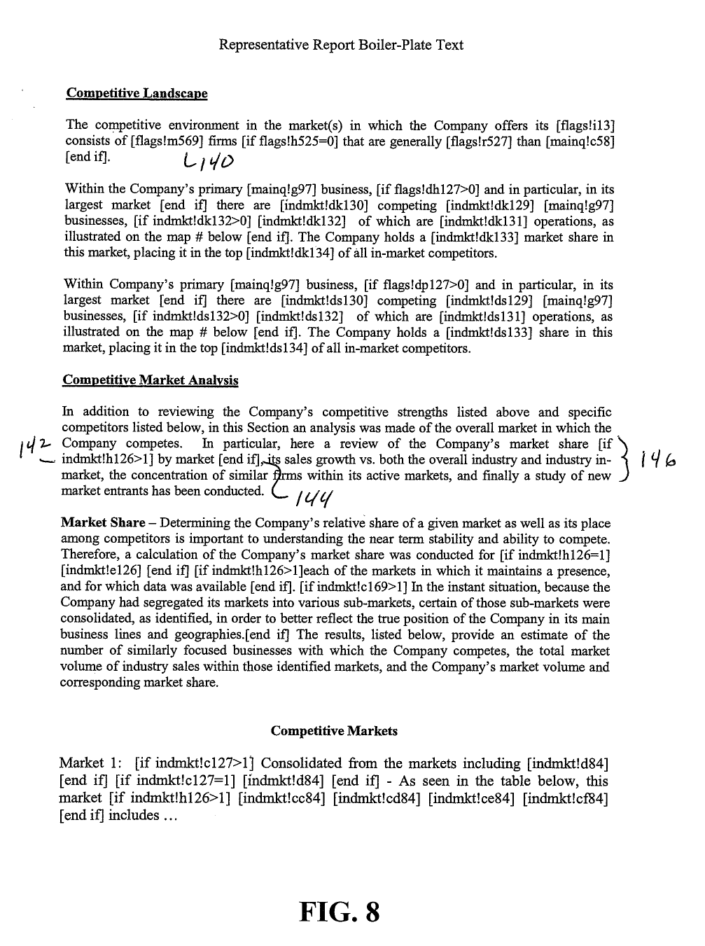

A exemplary template for an illustrative narrative report is provided in FIG. 8. The template includes placeholders for incorporating calculated values and selection or decision criteria for selecting boilerplate text to be included in the narrative report. In FIG. 8, the placeholders and selection criteria are enclosed in square brackets (“[” and “]”). A placeholder references a value stored in the system. The value may be from an input form, such as a company name, or may be a calculated value such as a market share. When the template is evaluated, the placeholders are replaced by the value they reference. For example, placeholder 140 in FIG. 8, “[flags!m569]” may refer to the number of competing companies in a particular industry.

While placeholders are replaced by the value they represent, selection criteria determine what boilerplate text is included in the narrative report. The selection criteria are expressions involving the various input or calculated values. If a criteria is True, then the corresponding text is included in the narrative report; otherwise, the text is omitted. For example, selection criteria 142, “[if indmkt!h126>1]” tests whether the company is in more than one market. If the test is true, then the narrative includes the text between selection criteria 142 and corresponding “[end if]” 144. Thus, sentence 146 reads “ . . . a review of the Company's market share, its sales growth . . . ” if the company is only in one market, but reads “ . . . a review of the Company's market share by market, its sales growth . . . ” if there is more than one market.

One skilled in the art will readily understand that other constructs or statements may be included in the templates such as constructs for looping over a list of values, or select one or more values from a list. Generally, a template system may include constructs or statements analogous to those found in a general purpose programming language. Similarly, template systems use a wide variety of syntax for the placeholders and selection criteria.

Thus, a system and method are provided for performing competitive business and/or financial analyses. The systems accepts input concerning a specific business such as the industries and geographical markets in which the business operates. Based on the type of report selected, the system retrieves business and financial data concerning the industries and markets, and then computes a number of relevant statistical factors. A tabular report is generated including the computed statistics and compare the particular business to other businesses in its present or prospective marketplaces. A narrative report may also be prepared based on the computed factors.

What is claimed:

1. A method for providing a competitive business analysis comprising:
accepting input data from a client business, the data including an identification of a client business industry, a geographic sales territory, and historic or forecast sales by geographic sales territory;
querying a database to obtain information on other businesses relevant to the analysis, including the industry, location, geographic sales territory, and sales for the other businesses;
analyzing the input data and the obtained information; and
providing a competitive analysis.

2. The method of claim 1 further comprising selecting a specific analysis from a predetermined plurality of analyses.

3. The method of claim 2, wherein querying a database comprises querying the database responsive to the selected analysis.

4. The method of claim 2, wherein the predetermined plurality of analyses comprises at least one of:
market share;
market share by class;
market share by trend;
concentration index;
comparative growth;
sales per employee; and
efficiency index.

5. The method of claim 1, wherein the provided competitive analysis is in the form of a narrative description of the results.

6. The method of claim 1, wherein the geographical data is at the level of detail of street addresses.

7. The method of claim 1 further comprising segregating the information obtained from the database by industry classification.

8. The method of claim 1 further comprising segregating the information obtained from the database by geographic area or location.

9. The method of claim 1 further comprising accepting an indication of prospective industries or markets.

10. The method of claim 9 wherein querying the database comprises querying the database to efficiently obtain information for both current and prospective industries or markets.

11. The method of claim 10 further comprising segregating the obtained information by industry and geography and analyzing the segregated information to produce separate business analysis for each identified market and industry.

12. Apparatus for performing a competitive market analysis comprising:
a general purpose computer including a data input device, a data output devices, a data storage device, and a network interface, the general purpose computer being programmed to:
accept input data regarding a client business, the data including identification of a client business industry, size and location of a geographic sales territory, and historic or forecast sales by geographic sales territory;
querying a database to obtain information on other businesses relevant to the analysis, including information on an industry, geographic sales territory, and sales of the other business;
analyzing the input data and the obtained information; and
providing the results of the analysis.

13. The apparatus of claim 12, wherein the general purpose computer is further programmed to accept a selection of a specific analysis from a predetermined plurality of analyses;

14. The apparatus of claim 13, wherein the predetermined plurality of analyses comprises at least one of:
market share;
market share by class;
market share by trend;
concentration index;
comparative growth;
sales per employee; and
efficiency index.

15. The apparatus of claim 12, wherein the business data include geographical data related to sales territories.

16. The apparatus of claim 15, wherein the geographical data is at the level of detail of street addresses.

17. The apparatus of claim 12 further comprising segregating the information obtained from the database by industry classification.

18. The apparatus of claim 12 further comprising segregating the information obtained from the database by geographic area or location.

19. The apparatus of claim 12 further comprising accepting an indication of prospective industries or markets.

20. The apparatus of claim 12, wherein querying the database comprises querying the database to efficiently obtain information for both current and prospective industries or markets.

21. The apparatus of claim 20 further comprising segregating the obtained information by industry and geography and analyzing the segregated information to produce separate business analysis for each identified market and industry.

22. A method of competitive business analysis comprising:
accepting input data from a client business, the data including an identification of a client business industry, a geographic sales territory delineated by a distance or estimated drive time from a specified location;
querying a database to obtain information on other businesses relevant to the analysis, including the industry, location, geographic sales territory, and sales for the other businesses;
analyzing the input data and the obtained information; and
providing the results of the analysis.
